(19) United States
(12) Patent Application Publication
(10) Pub. No.: US 2016/0189261 A1
(43) Pub. Date: Jun. 30, 2016

(54) Method and System for E-Auction

(71) Applicants: SHAILENDRA RAO, MUMBAI (IN); KRISHNA KANAUJIA, MUMBAI (IN)

(72) Inventors: SHAILENDRA RAO, MUMBAI (IN); KRISHNA KANAUJIA, MUMBAI (IN)

(21) Appl. No.: 14/846,759

(22) Filed: Sep. 5, 2015

(30) Foreign Application Priority Data
Dec. 30, 2014 (IN) 4219/MUM/2014

(51) Int. Cl. G06Q 30/06; G06Q 30/08

(52) U.S. Cl. CPC G06Q 30/0611; G06Q 30/08

(57) ABSTRACT

System intelligent interactive base for having supplier inputs and posing further questions to the supplier, including a portal system for conducting electronic auction requests for information, wherein buyer managing supplier inputs include an interconnection of at least one configurable and namable business process element. The system includes a host computer system, at least one database component associated with the host computer system, and a communication interface for accessing the host computer system from a plurality of remote input/output devices to manage the business process element. The system further includes a buyer on a web enabled handheld device (e.g., mobile devices and/or web based devices) and a supplier on a second web enabled handheld device (e.g., mobile devices and/or web based devices), in order to access a flexible price builder tab for capturing requests for information sought by the buyer from various suppliers for the purpose of conducting electronic auctions.

### CROSS-REFERENCE TO RELATED APPLICATION

The instant application claims priority to Indian Patent Application Ser. No. 4219/MUM/2014, filed Dec. 30, 2014, the entire specification of which is expressly incorporated herein by reference.

### FIELD OF THE INVENTION

The present invention relates generally to a system including a computer assisted business method for generating requests for proposals for products and services and submissions of proposals responding thereto. More specifically, the present invention relates to a system and method for automatically identifying, matching and interacting buyers and suppliers in proposed electronic commercial transactions.

### BACKGROUND OF THE INVENTION

A well-established process for initiating commercial transactions involves a potential buyer creating what is known as a request for proposal or a request for pricing (RFP) and identifying one or more potential vendors to direct the request to. Traditionally, such procedures have involved creating a written document (the RFP) and mailing the same to any of a number of possible appropriate supplier who then review the written document and prepare a proposal or price quote in return. Such a proposal or price quote is typically also a written document that is mailed back to the prospective buyer, along with any information that might influence the buyer's decision. The buyer may then wait a period of time until a sufficient number of proposals have been received to permit a decision to be made regarding the transaction. Once the buyer has reviewed the various proposals and the information provided by the suppliers, a choice is made with respect to a specific supplier and a purchase order is issued.

This basic process, though well-established in the commercial field, involves time-consuming efforts, not only in the transmittal of documents back and forth between the buyer and prospective suppliers, but also in the process of research and selection of the specific suppliers to whom the RFP is directed. A significant amount of time is involved in reviewing materials, both prior to directing an RFP to a potential supplier and further reviewing materials after a proposal has been received. It is not unusual for the process to take days, weeks, or even months when significant quantities and costs of products are involved.

The most basic modern embodiment of electronic commerce consists of a salesman using a telephone and a facsimile machine to negotiate a sale with a buyer. In this system, two parties negotiate the various components of the transaction, which may include, among other things, the quantity of goods to be purchased, the performance specifications of the goods, the payment terms, and delivery requirements. If the parties are informed and efficient in their bargaining, a transaction may be completed with one phone call. If there is uncertainty or ignorance on either side of the transactions, several calls may be necessary to complete the transaction. The buyer may take time to solicit other suppliers, shopping on the basis of price, availability, quality, and so on. The supplier, in the meantime, may have to investigate logistics issues, discount pricing possibilities, or the quantity of the goods in inventory. These activities cost both parties' time and money that could be better allocated to more profitable pursuits.

Some efforts have been made with the advent of commercial transactions occurring over wide area computer networks and the like to facilitate the process of identifying and matching buyers with appropriate suppliers of goods and services. In most cases the effort in this area has focused on providing online catalogs for suppliers to present their product information to prospective buyers. The process whereby a buyer offers a request for proposal or pricing is by its nature more difficult to implement in an online environment.

None of these systems provide for buyer and supplier interaction. Therefore, it would be desirable to have a system whereby a prospective buyer could direct a request for proposal to an automatically selected group of appropriate potential suppliers without the need for significant review of the materials and information provided by the suppliers. Accordingly, the present invention overcomes these problems by accomplishing the following objects.

### SUMMARY OF THE INVENTION

It is therefore an object of the present invention to provide a system intelligent interactive base for having supplier inputs and posing further questions to the supplier and a method for an online flexible price builder that adds increased functionality to a pricing table creation process and makes it easy to use and flexible for both buyers and suppliers.

It is a further object of the present invention for creating an interactive base for interaction between buyers and suppliers for performing the RFP stage of an electronic auction, thus creating an interactive base for interaction between buyers and suppliers such that the interactive base uses pre-defined decision rules in real time to automatically define and regulate interactions between suppliers and buyers.

In accordance with a first illustrative embodiment of the present invention, a system for conducting electronic sourcing requests for information using a flexible price builder system is provided, wherein buyer managing supplier inputs having an interconnection of at least one configurable and namable business process element, comprising:

a host computer system;

at least one database component associated with the host computer system; and

a communication interface for accessing the host computer system from a plurality of remote input/output devices to manage the flexible price builder business process element.

In accordance with an aspect of this first illustrative embodiment of the present invention, the system further comprises a buyer side web-enabled handheld device and a supplier side web-enabled handheld device for accessing the flexible price builder system for capturing a request for information sought by the buyer from various suppliers for the purpose of conducting electronic auctions.

In accordance with an aspect of this first illustrative embodiment of the present invention, the system creates e-sourcing content, questions or pricing tables, for suppliers such that, based on certain predefined buyer defined rules, automatic activities may be triggered without any user intervention.

In accordance with an aspect of this first illustrative embodiment of the present invention, the automatic activities further includes the auto creation, deletion or modification of information required from the supplier based on parameters including at least one of predefined buyer rules, responses of other suppliers in the same event, historically submitted responses by other suppliers, and information obtained from other third party supplier information systems.

In accordance with an aspect of this first illustrative embodiment of the present invention, the system further comprises a system for a supplier to insert the inputs using a user interface available on a mobile application in accordance with a pricing table setup, wherein an output is provided to the buyer on the mobile device through the system, wherein each field that requires supplier inputs are preconfigured with tolerance limits, wherein once the inputs are provided by the supplier to the pricing table, the pre-configured tolerance limits attached to the input fields are mapped to the inputs provided by the supplier based on deviations to the tolerance limits, wherein scores are provided by the system to each supplier input.

In accordance with an aspect of this first illustrative embodiment of the present invention, a conditional formatting mapping system generates, modifies, or deletes further questions to the supplier for inputs (e.g., based on the scores generated by the system).

In accordance with a second illustrative embodiment of the present invention, a method for conducting electronic sourcing requests for information using a flexible price builder system is provided, wherein buyer managing supplier inputs having an interconnection of at least one configurable and namable business process element, comprising:

providing a host computer system;

providing at least one database component associated with the host computer system; and

providing a communication interface for accessing the host computer system from a plurality of remote input/output devices to manage the flexible price builder business process element.

In accordance with an aspect of this second illustrative embodiment of the present invention, the method further comprises the step of providing a buyer side web-enabled handheld device and a supplier side web-enabled handheld device for accessing the flexible price builder system for capturing a request for information sought by the buyer from various suppliers for the purpose of conducting electronic auctions.

In accordance with an aspect of this second illustrative embodiment of the present invention, the system creates e-sourcing content, questions or pricing tables, for suppliers such that, based on certain predefined buyer defined rules, automatic activities may be triggered without any user intervention.

In accordance with an aspect of this second illustrative embodiment of the present invention, the automatic activities further includes the auto creation, deletion or modification of information required from the supplier based on parameters including at least one of predefined buyer rules, responses of other suppliers in the same event, historically submitted responses by other suppliers, and information obtained from other third party supplier information systems.

In accordance with an aspect of this second illustrative embodiment of the present invention, the method further comprises the step of:

providing a system for a supplier to insert the inputs using a user interface available on a mobile application in accordance with a pricing table setup, wherein an output is provided to the buyer on the mobile device through the system, wherein each field that requires supplier inputs are preconfigured with tolerance limits, wherein once the inputs are provided by the supplier to the pricing table, the pre-configured tolerance limits attached to the input fields are mapped to the inputs provided by the supplier based on deviations to the tolerance limits, wherein scores are provided by the system to each supplier input.

In accordance with an aspect of this second illustrative embodiment of the present invention, a conditional formatting mapping system generates, modifies, or deletes further questions to the supplier for inputs (e.g., based on the scores generated by the system).

For example, the user could manage an element of the system and method for conducting electronic sourcing requests for information using a flexible price builder on a handheld mobile device (e.g., cellular phone, smartphone, PDA, laptop computer, tablet computer, and/or any other like device that is selectively operable to communicate with the host computer system (or component thereof) through a wired and/or wireless connection) for which management needs to be done for.

These and other objects and advantages of the present invention will become apparent from a reading of the following specification and appended claims. There has thus been outlined, rather broadly, the more important features of the present invention in order that the detailed description thereof that follows may be better understood, and in order that the present contribution to the art may be better appreciated. There are features of the present invention that will be described hereinafter and which will form the subject matter of the claims appended hereto.

### BRIEF DESCRIPTION OF THE DRAWINGS

FIG. 1 is a screen shot of one embodiment of the present invention showing the working screen for a pricing table, having the ‘Question Type’ menu at the time of event creation.

FIG. 2 is a screen shot of one embodiment of the present invention showing the working screen for creating an item table through a user interface (UI) as per an old functionality of selecting required item settings and adding item details.

FIG. 3 is a screen shot of one embodiment of the present invention showing a working screen, wherein users may select and upload an existing EXCEL file. The supported file type may be .xlsx (MS OFFICE 2010 and onwards). The imported file may be displayed on a user interface similar to how it looks in EXCEL, but it is not editable online.

FIG. 4 is a screen shot of one embodiment of the present invention showing a working screen enabling a user to map the EXCEL file through a quick six step procedure in order to interpret the EXCEL file by the system as a pricing table. The use may select the EXCEL work sheet that contains the requisite pricing information and the system may seek further information on item details and pricing within this sheet.

FIG. 5 is a screen shot of one embodiment of the present invention showing a working screen including column headers in an EXCEL file structure may be multi-level, detailed and may span across the first few rows, whereby entering the row number where a header ends so that the system may identify where the item details begin.

FIG. 6 is a screen shot of one embodiment of the present invention showing a working screen wherein a user may make a selection to define whether a pricing table contains a single level item hierarchy. In other words, if the pricing table contains a parent child relationship such that one or more components build up to a part, then select “Yes,” otherwise, select “No.”

FIG. 7 is a screen shot of one embodiment of the present invention showing a working screen illustrating, if there is a parent child hierarchy, then define the column that contains the parent child flag. The parent child flag is a way of identifying whether items in a pricing table contains one level breakup into components. It is a simple column, with any possible header name, and two input values: alphabets “P” and “C,” wherein P stands for Parent and C stands for Child. In the example, shown on a user interface Desktop is a parent item consisting of Child items Monitor, CPU and Keyboard.

FIG. 8 is a screen shot of one embodiment of the present invention showing a working screen depicting that the imported EXCEL file has a mapped primary sheet from Step 1: of identifying primary sheet, using the column headers in this primary sheet to identify and map information that is required for the system to interpret the EXCEL file as a pricing table. The information that requires mandatory mapping in this step may be an item number, item name, required quantity, unit of measure of the required quantity and/or total cost.

FIG. 9 is a screen shot of one embodiment of the present invention showing a working screen wherein a user may then bucket remaining columns into Unit Cost, Fixed Cost and Formula using simple drag and drop functionality. This way, the system may interpret these fields as pricing information and make them available in such downstream functionality as view response, collect stage exports, analyze stage exports and/or bid analysis.

FIG. 10 is a screen shot of one embodiment of the present invention showing a working screen showing the final step, wherein a user may define the cells that are meant for suppliers: as mandatory and non-mandatory based on their color codes/fill.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

In accordance to the present embodiment of the present invention, there is provided a system intelligent interactive base for having supplier inputs and posing further questions to the supplier, more preferably, a portal system for conducting electronic auction request for information, wherein buyer managing supplier inputs including an interconnection of at least one configurable and namable business process element. The system includes a host computer system, at least one database component associated with the host computer system, and a communication interface for accessing the host computer system from a plurality of remote input/output devices to manage the business process element. The system further includes a buyer on a web enabled handheld device selected from the group consisting of but not limited to mobile, IPHONE, IPAD, ANDROID device, WINDOWS device, BLACKBERRY and any web based devices and the supplier on a second web enabled handheld device selected from the group consisting of but not limited to mobile, IPHONE, IPAD, ANDROID device, WINDOWS device, BLACKBERRY and any web based devices, in order to access a flexible price builder tab for capturing requests for information sought by the buyer from various suppliers for the purpose of conducting electronic auctions.

The system of the present invention is advantageous when quotes are required for more open ended pricing/item structure as well as for more complex pricing modeling consisting of EXCEL file with multiple sheets, across sheet formulas, single level parent-child item structure, comprehensive EXCEL formulas such as conditional formulae, VLOOKUP and multiple colors in EXCEL, etc.

The Flexible Price Builder may be a system and method to create e-sourcing content, questions or pricing tables, for suppliers such that based on certain predefined buyer defined rules automatic activities may be triggered without user intervention. Thus, there exists automatically, triggerable activities such as: (1) supplier interaction may be controlled, i.e., certain fields may become mandatory or non-mandatory on the fly. System intelligent interactive base for having supplier inputs and posing further questions to the supplier; (2) Automatic scoring of supplier response may be done and feedback may be provided to suppliers on the fly; (3) Supplier may be automatically promoted to next setups, such as a next round of negotiation, or demoted or blocked, etc.; (4) Help content may be presented dynamically if the supplier is facing an issues; (5) Supplier's position, relative to other suppliers, may be determined automatically in dynamic situations such as auctions; (6) Supplier interaction may be controlled, i.e., certain fields may become mandatory or non-mandatory on the fly thereby providing a system intelligent interactive base for having supplier inputs and posing further questions to the supplier; (7) Automatic scoring of supplier response may be done and feedback may be provided to suppliers on the fly; (8) Supplier may be automatically promoted to next setups, such as a next round of negotiation, or demoted or blocked, etc.; (9) Help content may be presented dynamically if the supplier is facing an issues; and (10) Supplier's position, relative to other suppliers, may be determined automatically in dynamic situations such as auctions.

Thus, once the supplier inserts the inputs using the user interface available on the mobile application in accordance to the pricing table setup, the output may be provided to the buyer on its mobile device through the system, each field which requires supplier inputs are preconfigured with some tolerance limits, therefore once the inputs are provided by the supplier to the pricing table, the pre-configured tolerance limits attached to the input fields are mapped to the inputs provided by the supplier based on the deviations to the tolerance limits, the scores are provided by the system to each supplier pricing table inputs. Therefore, based on the scores generated by the system the conditional formatting mapping generates further questions to the supplier for inputs and again the above process continues as an interactive base, until the system freezes the inputs of supplier with final scores and analyses the top three suppliers as selected suppliers.

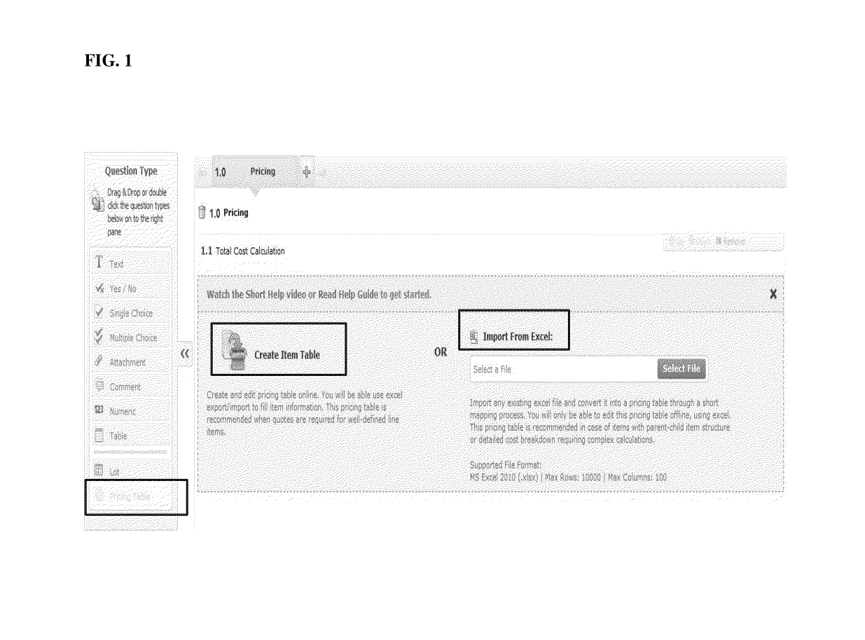

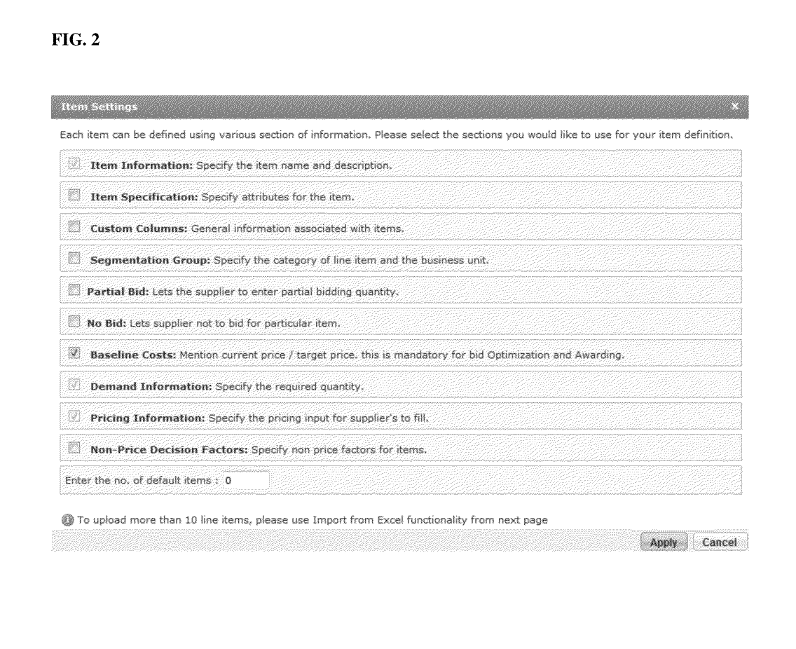

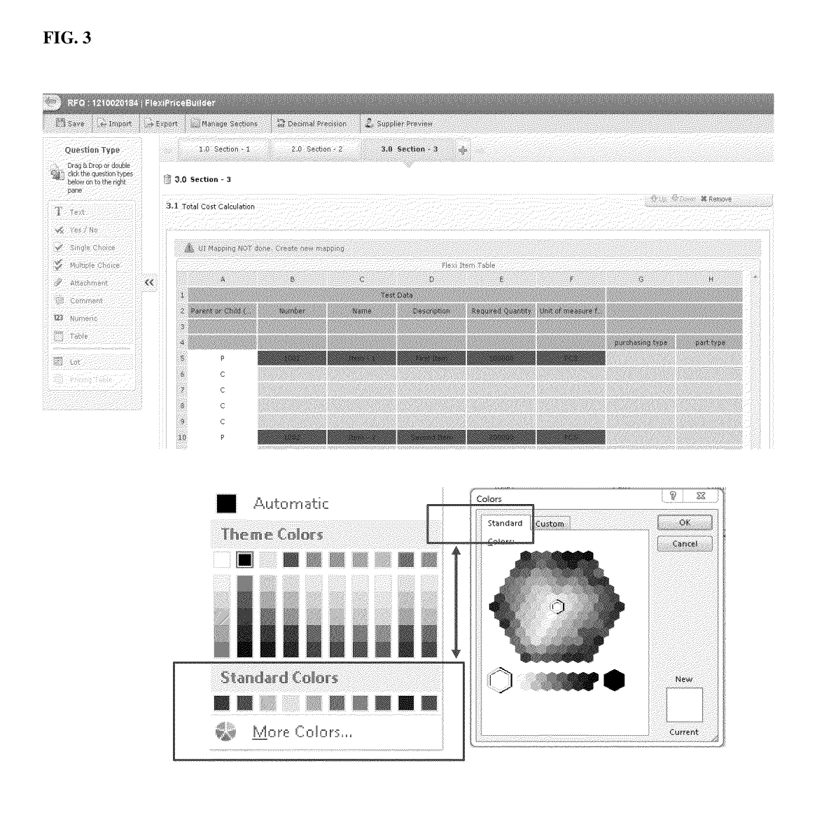

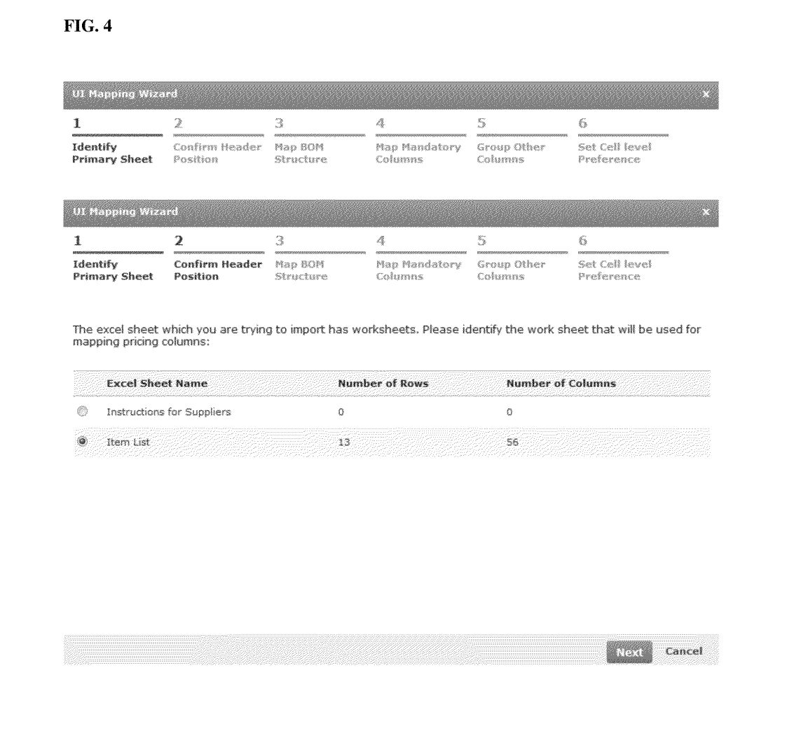

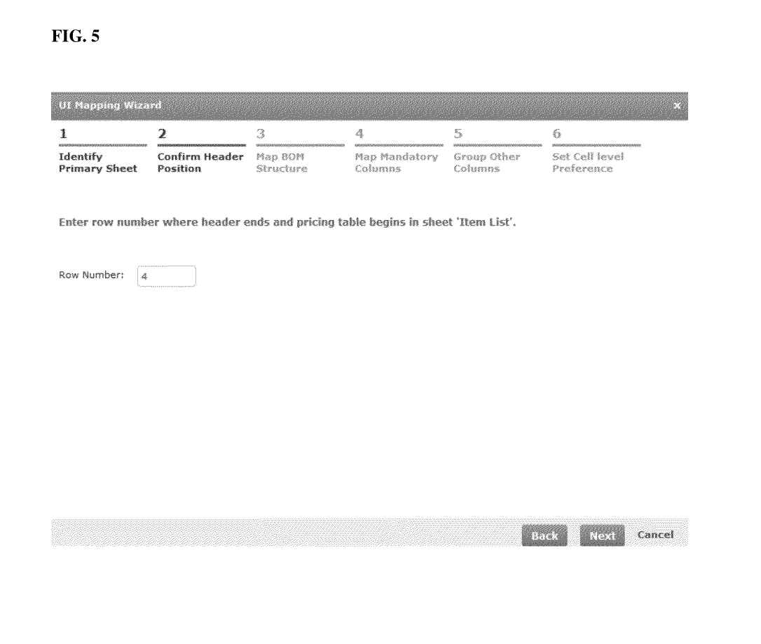

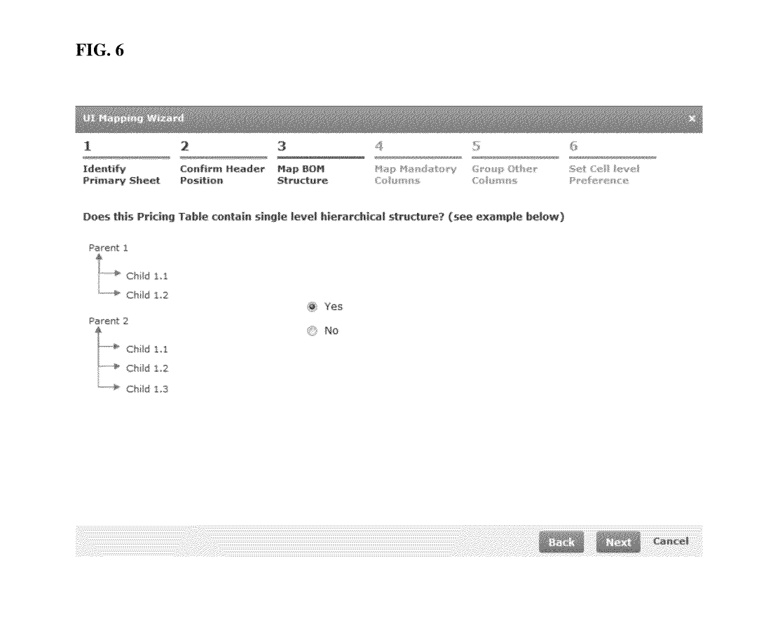

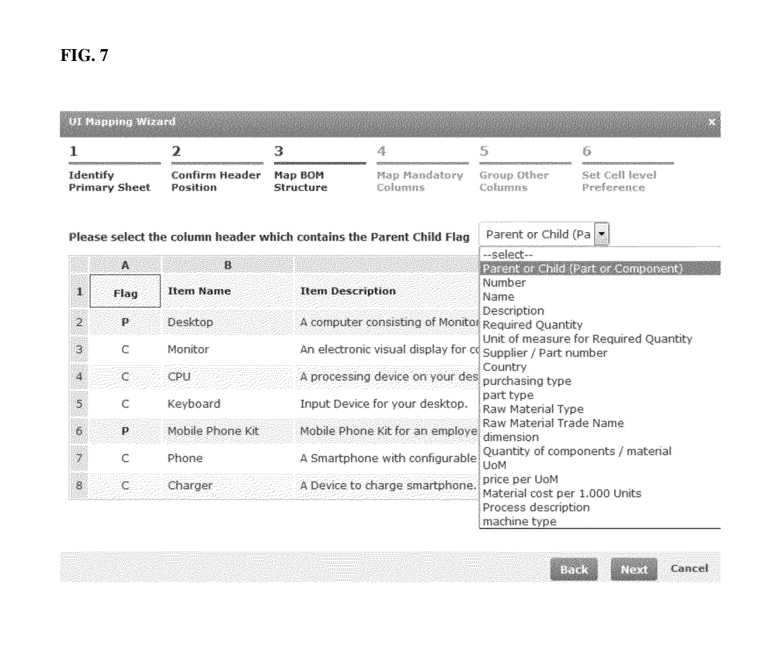

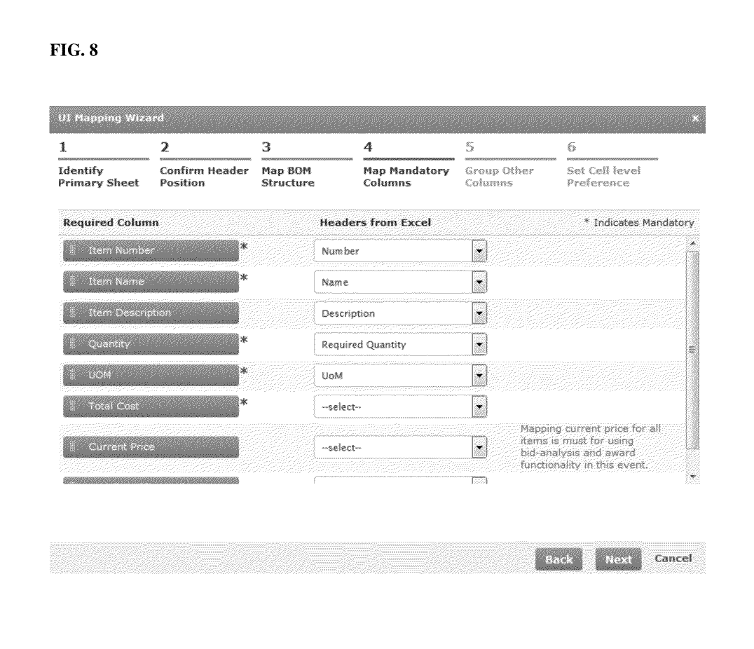

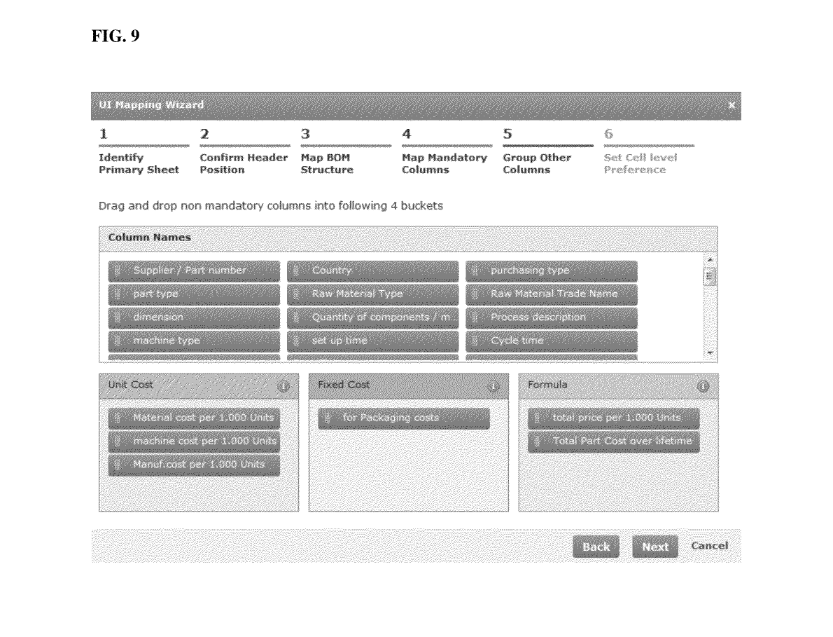

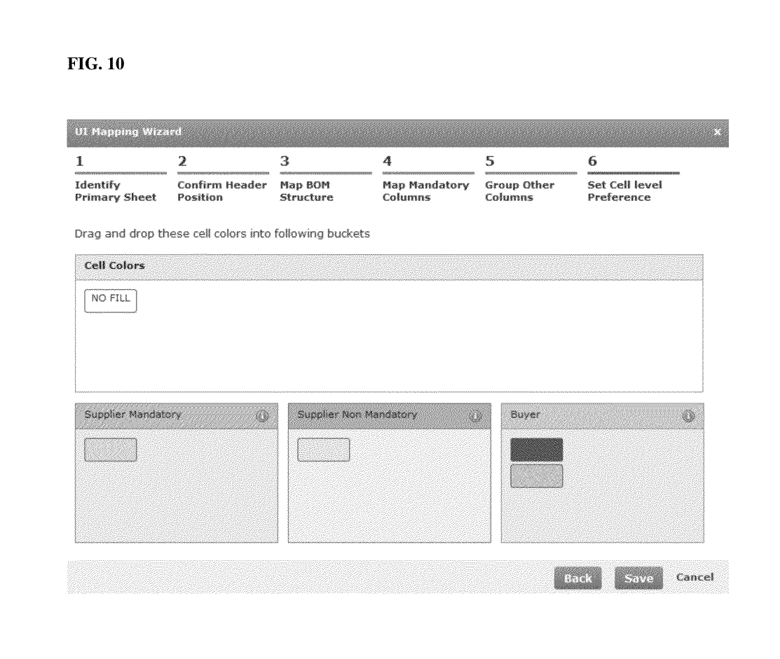

The present invention herein, discussed as show in FIGS. 1 to 10, wherein, FIG. 1 is a screen shot of one embodiment of the present invention showing the working screen for pricing table; for creating the item table through user interface (UI) as per an old functionality of selecting required item settings and adding item details. Users may select and upload an existing EXCEL file. The supported file type may be .xlsx (MS OFFICE 2010 onwards). The imported file is displayed on user interface similar to how it looks in EXCEL but it is not editable online.

Further, a user may be able to map the EXCEL file through a quick six step procedure in order to interpret the EXCEL file by the system as a pricing table. The user may select the EXCEL work sheet that contains the requisite pricing information and the system seeks further information on item details and pricing within this sheet, wherein columns headers in EXCEL file structure may be multi-level, detailed and may span across first few rows whereby entering the row number where header ends so that the system may identify where the item details begin.

The user may make a selection to define whether pricing table contains a single level item hierarchy. In other words, if the pricing table contains a parent child relationship such that one or more components build up to a part, then select “Yes,” otherwise, select “No,” if there is a parent child hierarchy, then define the column that contains the parent child flag. Parent child flag may be a way of identifying whether items in pricing table contains one level breakup into components. It is a simple column, with any possible header name, and two input values: alphabets “P” and “C” wherein P stands for Parent and C stands for Child. In the example, shown on the user interface Desktop may be a parent item consisting of Child items Monitor, CPU and Keyboard.

Thus, the imported EXCEL file may have a mapped primary sheet from Step 1: of identifying a primary sheet, using the column headers in this primary sheet to identify and map information that may be required for the system to interpret the EXCEL file as a pricing table. The information that requires mandatory mapping in this step may be item number, item name, required quantity, unit of measure of the required quantity and total cost. Further user is able to bucket remaining columns into Unit Cost, Fixed Cost and Formula using simple drag and drop functionality. This way, the system may interpret these fields as pricing information and make them available in such downstream functionality as view response, collect stage exports, analyze stage exports and bid analysis. Subsequently in the final step, the user may define the cells that are meant for suppliers: as mandatory and non-mandatory, based on their color codes/fill.

In the supplier side impact, the suppliers may be able to download and input data into the EXCEL file. The EXCEL file generated on the supplier side may automatically lock the cells that are not meant to be edited by the supplier and validate, at the time of import, whether all mandatory information has been filled or not. The downstream impact, wherein the rest of the system functionality, including collect stage, analyze stage and bid analysis, works in the current way without any changes. Importantly, only the mapped pricing fields may show up in these downstream steps and not all the columns from the imported EXCEL file.

Further, once the supplier inserts the inputs in accordance to the pricing table setup, it may provide the same to the buyer through the system, each field that requires supplier inputs may be preconfigured with some tolerance limits. Therefore, once the inputs are provided by the supplier to the pricing table, the pre-configured tolerance limits attached to the input fields may be mapped to the inputs provided by the supplier based on the deviations to the tolerance limits, the scores may be provided by the system to each supplier pricing table inputs. Based on the scores generated by the system, the conditional formatting mapping may generate further questions to the supplier for inputs. Again, the above process may continue as an interactive base, until the system freezes the inputs of suppliers with final scores and analyses the top three suppliers as selected suppliers.

Thus, the flexible pricing model of the present invention supports such as, a single level item hierarchy that may be used for bill of materials (BOM), EXCEL formulas such as conditional formulas, VOOKLUP, etc., across sheet formulas, EXCEL file with multiple sheets that may be used to break down large pricing tables, different formulas per item (row) that may be used to model complex pricing breakup and use of colors in EXCEL that may be used to differentiate buyer fields from supplier fields.

Moreover, the system has now eliminated the need for creating large pricing tables online. All it requires is a quick mapping process to translate an existing EXCEL template into a pricing table online. In addition, supplier side usability may be enhanced by use of multiple sheets that allows a buyer to put detailed descriptions/instructions for the supplier' s ease of understanding of the pricing table and use of colors for differentiating suppliers' fields from buyers' fields.

Using the pricing model of the present invention to create a new pricing table in an event is user friendly because the pricing table may be directly created from the EXCEL file without starting from scratch on-line. Moreover, events with flexible pricing tables are also reusable if created as templates or when re -used under a “copy from existing” feature. Therefore, through the system, the inputs of the supplier may be analyzed and, through the system, the suppliers may be selected automatic activities further includes the auto creation or deletion or modification information required from the supplier based on various parameters including at least predefined buyer rules, responses of other suppliers in the same event, historically submitted responses by other suppliers, information obtained from other third party supplier information systems and/or the like.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that may store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical smayner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for conducting electronic sourcing requests for information using a flexible price builder system, wherein buyer managing supplier inputs having an interconnection of at least one configurable and namable business process element, comprising:
a host computer system;
at least one database component associated with the host computer system; and
a communication interface for accessing the host computer system from a plurality of remote input/output devices to manage the flexible price builder business process element.

2. The system as claimed in claim 1, further comprising a buyer side web-enabled handheld device and a supplier side web-enabled handheld device for accessing the flexible price builder system for capturing a request for information sought by the buyer from various suppliers for the purpose of conducting electronic auctions.

3. The system as claimed in claim 1, wherein the system creates e-sourcing content, questions or pricing tables, for suppliers such that, based on certain predefined buyer defined rules, automatic activities may be triggered without any user intervention.

4. The system as claimed in claim 3, wherein the automatic activities further includes the auto creation, deletion or modification of information required from the supplier based on parameters including at least one of predefined buyer rules, responses of other suppliers in the same event, historically submitted responses by other suppliers, and information obtained from other third party supplier information systems.

5. The system as claimed in claim 1, further comprising:
a system for a supplier to insert the inputs using a user interface available on a mobile application in accordance with a pricing table setup, wherein an output is provided to the buyer on the mobile device through the system, wherein each field that requires supplier inputs are preconfigured with tolerance limits, wherein once the inputs are provided by the supplier to the pricing table, the pre-configured tolerance limits attached to the input fields are mapped to the inputs provided by the supplier based on deviations to the tolerance limits, wherein scores are provided by the system to each supplier input.

6. The system as claimed in claim 5 wherein, based on the scores generated by the system, a conditional formatting mapping system generates, modifies, or deletes further questions to the supplier for inputs.

7. A method for conducting electronic sourcing requests for information using a flexible price builder system, wherein buyer managing supplier inputs having an interconnection of at least one configurable and namable business process element, comprising:
providing a host computer system;
providing at least one database component associated with the host computer system; and
providing a communication interface for accessing the host computer system from a plurality of remote input/output devices to manage the flexible price builder business process element.

8. The method as claimed in claim 7, further comprising the step of providing a buyer side web-enabled handheld device and a supplier side web-enabled handheld device for accessing the flexible price builder system for capturing a request for information sought by the buyer from various suppliers for the purpose of conducting electronic auctions.

9. The method as claimed in claim 7, wherein the system creates e-sourcing content, questions or pricing tables, for suppliers such that, based on certain predefined buyer defined rules, automatic activities may be triggered without any user intervention.

10. The method as claimed in claim 9, wherein the automatic activities further includes the auto creation, deletion or modification of information required from the supplier based on parameters including at least one of predefined buyer rules, responses of other suppliers in the same event, historically submitted responses by other suppliers, and information obtained from other third party supplier information systems.

11. The method as claimed in claim 7, further comprising the step of:
providing a system for a supplier to insert the inputs using a user interface available on a mobile application in accordance with a pricing table setup, wherein an output is provided to the buyer on the mobile device through the system, wherein each field that requires supplier inputs are preconfigured with tolerance limits, wherein once the inputs are provided by the supplier to the pricing table, the pre-configured tolerance limits attached to the input fields are mapped to the inputs provided by the supplier based on deviations to the tolerance limits, wherein scores are provided by the system to each supplier input.

12. The method as claimed in claim 11, wherein, based on the scores generated by the system, a conditional formatting mapping system generates, modifies, or deletes further questions to the supplier for inputs.
